(19) United States
(12) Patent Application Publication
(10) Pub. No.: US 2025/0219994 A1
(43) Pub. Date: Jul. 3, 2025

(54) COMMUNICATION CONTROL DEVICE, COMMUNICATION CONTROL METHOD, AND COMMUNICATION CONTROL PROGRAM

(71) Applicant: Nippon Telegraph and Telephone Corporation, Tokyo (JP)

(72) Inventors: Yuta WATANABE, Musashino-shi, Tokyo (JP); Yuhei HAYASHI, Musashino-shi, Tokyo (JP); Yuki TAKEI, Musashino-shi, Tokyo (JP)

(21) Appl. No.: 18/848,773

(22) PCT Filed: Mar. 28, 2022
(86) PCT No.: PCT/JP2022/015099

§ 371 Date: Sep. 19, 2024

(51) Int. Cl. H04L 9/40; H04L 12/46

(52) U.S. Cl. CPC H04L 63/0236; H04L 12/4641

(57) ABSTRACT

A security device (10) detects unauthorized communication in each of VLANs in a network in which each edge device (20) is logically divided into different VLANs. Also, when detecting unauthorized communication, the security device (10) publicizes predetermined data in the VLAN in which the unauthorized communication is detected and identifies the edge device (20) in the VLAN based on the response to the publicity. Subsequently, the security device (10) instructs the identified edge device (20) to control communication against unauthorized communications.

### TECHNICAL FIELD

The present invention relates to a communication control device, a communication control method, and a communication control program.

### BACKGROUND ART

In the related art, although quality control functions which control high-quality communication have been deployed at the edge function close to subscriber terminals, there are expectations for centralized deployment in the cloud and the like due to rising costs due to distributed deployment.

On the other hand, centralized deployment makes flexible control impossible between subscriber terminals and quality control functions. In addition, there is a concern that the high-quality traffic of other users who are using the service properly will be discarded by attacks which send a large amount of high-quality traffic being carried out, leading to communication interruptions.

Normally, countermeasures can be taken by identifying the communication path from the attacking internet protocol (IP) address and instructing devices on the path to shut it down. However, in services with a large number of users, duplicate IP addresses may be issued to subscribers and the addresses may be logically divided and transferred using virtual local area networks (VLANs) or various tunnels. In such cases, it is not possible to identify the communication path using only the IP address. Thus, various information is managed using security devices or the like and the device which issues the blocking instruction is identified based on the detected information, and the device is blocked.

### CITATION LIST

### Non Patent Literature

[NPL 1] IDS Technique and Trends thereof, [online], [retrieved on Mar. 16, 2022], Internet <https://www.bcm.co.jp/site/security/security2-5.pdf>
[NPL 2] Frontline of Unauthorized Intrusion Countermeasures, [online], [searched on Mar. 16, 2022], Internet <https://atmarkit.itmedia.co.jp/fsecurity/special/07ids/ids01c.html>

### SUMMARY OF INVENTION

### Technical Problem

However, the technique in the related art has a problem in that it is not possible to appropriately control communication while reducing the cost of information management. For example, in the technique in the related art, when instructing to block, it is necessary to constantly update and manage information using security devices or the like so that the IP address and other information and information on the device to be controlled and communicated with can always be reliably identified. However, this requires manual work by an operator and software which automatically updates security devices when changes are provided to communication conditions, resulting in high costs.

In addition, for example, when broadcasting settings like BGP Flowspec, the receiving communication device determines whether settings are necessary and performs the settings, it is difficult to perform a determination when there are duplicate IP addresses and it is not possible to appropriately block communications.

The present invention was made in view of the above circumstances, and an object of the present invention is to provide a communication control device, a communication control method, and a communication control program which can appropriately control communication while reducing costs relating to information management.

### Solution to Problem

In order to solve the above-described problems and achieve the object of the present invention, a communication control device according to the present invention includes: a detection part which detects unauthorized communication in each of VLANs in a network in which each edge device is logically divided into different VLANs; an identification part which, when unauthorized communication is detected using the detection part, publicizes predetermined data in the VLAN in which the unauthorized communication was detected and identifies an edge device in the VLAN on the basis of a response to the publicity; and a communication control part which instructs the edge device identified using the identification unit to control communication with respect to the unauthorized communication.

### Advantageous Effects of Invention

According to the present invention, it is possible to appropriately control communication while reducing costs associated with information management.

### BRIEF DESCRIPTION OF DRAWINGS

FIG. 1 is a block diagram showing an example of a configuration of a communication system according to an embodiment.

FIG. 2 is a diagram showing an example of a communication path in the communication system according to the embodiment.

FIG. 3 is a block diagram showing a configuration of a security device of the embodiment.

FIG. 4 is a diagram showing a process in which the security device instructs to block unauthorized communication.

FIG. 5 is a flowchart for describing an example of a security processing procedure.

FIG. 6 is a diagram showing problems when using BGP Flowspec in the related art.

FIG. 7 is a diagram showing a computer which executes a program.

### DESCRIPTION OF EMBODIMENTS

Embodiments of a communication control device, a communication control method, and a communication control program according to the present application will be described in detail below on the basis of the drawings. Furthermore, the present invention is not limited to the embodiments described below.

### Configuration of Communication System

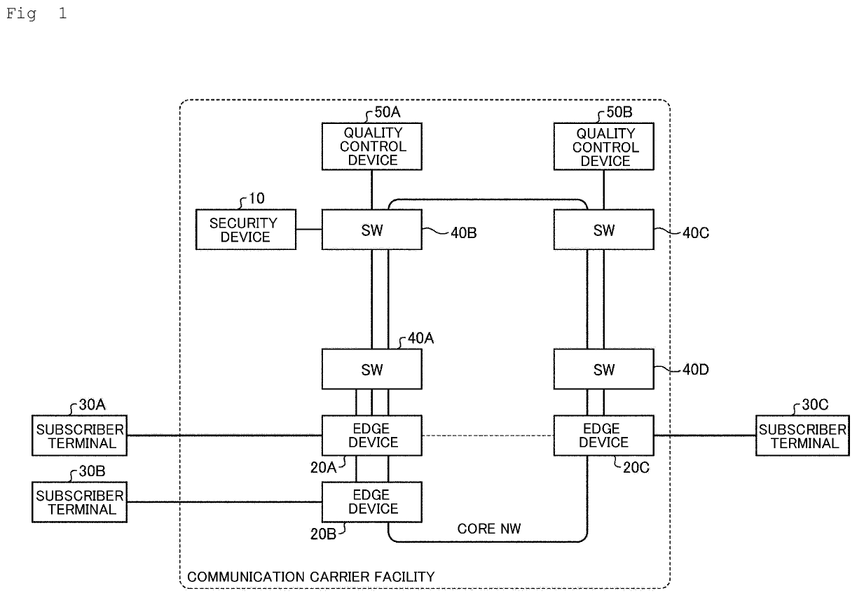

A configuration of a communication system according to an embodiment will be described. FIG. 1 is a block diagram showing an example of the configuration of the communication system according to an embodiment. As shown in FIG. 1, the communication system includes a security device (communication control device) 10, a plurality of edge devices 20A to 20C, a plurality of subscriber terminals 30A to 30C, a plurality of switches (SWs) 40A to 40D, and a plurality of quality control devices 50A and 50B.

Note that, when describing the plurality of edge devices 20A to 20C, the plurality of subscriber terminals 30A to 30C, the plurality of switches (SWs) 40A to 40D, and the quality control devices 50A and 50B without distinction, the edge device 20, the subscriber terminal 30, the SW 40, and the quality control device 50 are respectively referred to. Furthermore, the configuration shown in FIG. 1 is only an example and the specific configuration and the numbers of each device are not particularly limited.

In addition, in the communication system shown in FIG. 1, the premise is that communication using the mechanism handles particularly high-priority (high-quality) communication and that, particularly, a large amount of packet loss or communication interruption is unacceptable.

In the communication system, the edge devices 20A to 20C are logically divided into different VLANs. That is to say, in the communication system, for example, one of the edge devices 20, one of the quality control devices 50, and one of the security devices 10 are configured in a logically divided state such as one of the VLANs.

Furthermore, for example, in the communication system, if high-quality settings and large-capacity unauthorized communication is performed from the subscriber terminal 30, congestion will occur between the subscriber terminal 30 and the quality control device 50, resulting in a large amount of packet loss or communication interruption. For this reason, in the communication system, a security device 10 which can detect attacks on a route or at a location in which traffic can be duplicated and received is installed.

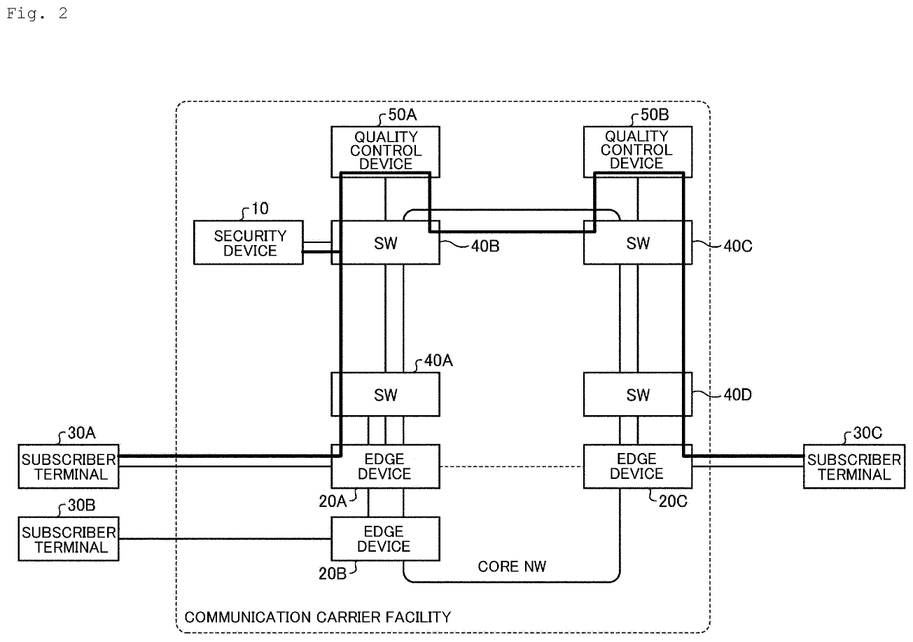

The security device 10 detects unauthorized communications and performs communication control to block unauthorized communications. Here, communication paths in the communication system will be explained using FIG. 2. FIG. 2 is a diagram showing an example of a communication path in the communication system according to the embodiment. As shown in FIG. 2, it is assumed that the subscriber terminal 30A transmits a packet to the subscriber terminal 30C via the edge device 20A, the SW 40A, the SW 40B, the SW 40C, the SW 40D, and the edge device 20C. In such a case, for example, the security device 10 detects unauthorized communication by receiving a copy of the packet from the SW 40B and analyzing the received packet.

The edge devices 20A to 20C and the switches (SWs) 40A to 40D are communication devices which transfer packets. Furthermore, the quality control devices 50A and 50B manage sessions and also perform quality control.

### Configuration of Security Device

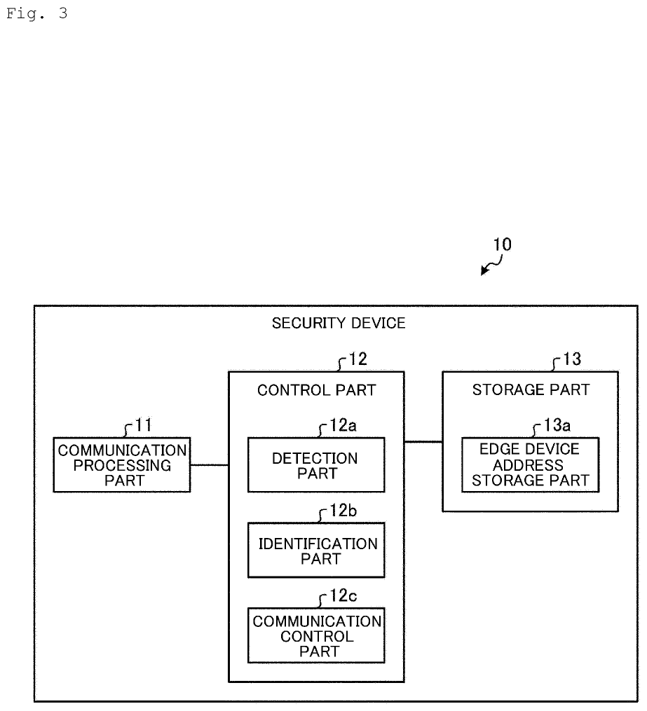

FIG. 3 is a block diagram showing a configuration of the security device of the embodiment. As shown in FIG. 3, the security device 10 of the embodiment includes a communication processing part 11, a control part 12, and a storage part 13.

The communication processing part 11 is realized by a network interface card (NIC) or the like and controls communication via a telecommunication line such as a local area network (LAN) or the Internet.

The storage part 13 stores data and programs necessary for various processing by the control part 12 and has an edge device address storage part 13a. For example, the storage part 13 is a semiconductor memory element such as a random access memory (RAM) or a flash memory or a storage device such as a hard disk or an optical disc. The edge device address storage part 13a stores the IP address of the edge device 20 identified by the identification part 12b, which will be described later.

The control part 12 has an internal memory for storing programs defining various processing procedures and required data and performs various processes using these programs and data. For example, the control part 12 includes a detection part 12a, an identification part 12b, and a communication control part 12c. Here, the control part 12 is an electronic circuit such as a central processing unit (CPU) or a micro processing unit (MPU) or an integrated circuit such as an application specific integrated circuit (ASIC) or a field programmable gate array (FPGA).

The detection part 12a detects unauthorized communication in each VLAN in a network in which each edge device 20 is logically divided into different VLANs. Note that any method may be used for detecting unauthorized communication. For example, in order to detect unauthorized communication, the detection part 12a counts the amount of data of transmitted packets in a predetermined period for each source IP address or destination IP address for each VLAN. Also, when the amount of data is a predetermined threshold value or more, the detection part 12a detects that there is unauthorized communication regarding the source IP address or destination IP address in the VLAN.

When the detection part 12a detects unauthorized communication, the identification part 12b publicizes predetermined data in the VLAN in which the unauthorized communication is detected and identifies the edge device 20 in the VLAN on the basis of the response to the publicity. As a method for identifying the edge device 20, the identification part 12b, for example, may identify the edge device 20 using a dynamic host configuration protocol (DHCP), identify the edge device 20 using a router publicity (RA), or identify the edge device 20 using other broadcast or multicast.

For example, the identification part 12b broadcasts a DHCP IP address request message (DHCP Discover message) into the VLAN in which unauthorized communication has been detected, receives a response to the message (DHCP Offer message) from the edge device 20 in the VLAN, and identifies the IP address of the edge device 20 in the VLAN from the information included in the received response.

For example, the identification part 12b multicasts, in the VLAN in which unauthorized communication has been detected, the RS message in the VLAN in which unauthorized communication has been detected, receives a response to the RA message as a response to the message, and identifies the IP address of the edge device 20 in the VLAN from the information included in the received response.

After specifying the IP address of the edge device 20, the identification part 12b stores the identified IP address of the edge device 20 in the edge device address storage part 13a.

The communication control part 12c instructs the edge device 20 identified using the identification part 12b to control communication against unauthorized communication. For example, the communication control part 12c notifies the edge device 20 identified using the identification part 12b of the IP address at which communication is to be blocked and instructs communication control to block communication regarding the IP address.

If explanation is provided more specifically, for example, the communication control part 12c reads the IP address of the identified edge device 20 from the edge device address storage part 13a, notifies the edge device 20 located in the VLAN in which the unauthorized communication has been detected of the IP address of the packet whose communication is to be blocked using the read IP address as the destination, and blocks the unauthorized communication. Note that, as a method for controlling communications against unauthorized communications, the communication control part 12c is not limited to the process of blocking packets relating to unauthorized communication, but may also, for example, perform processing such as reducing the communication rate relating to unauthorized communication.

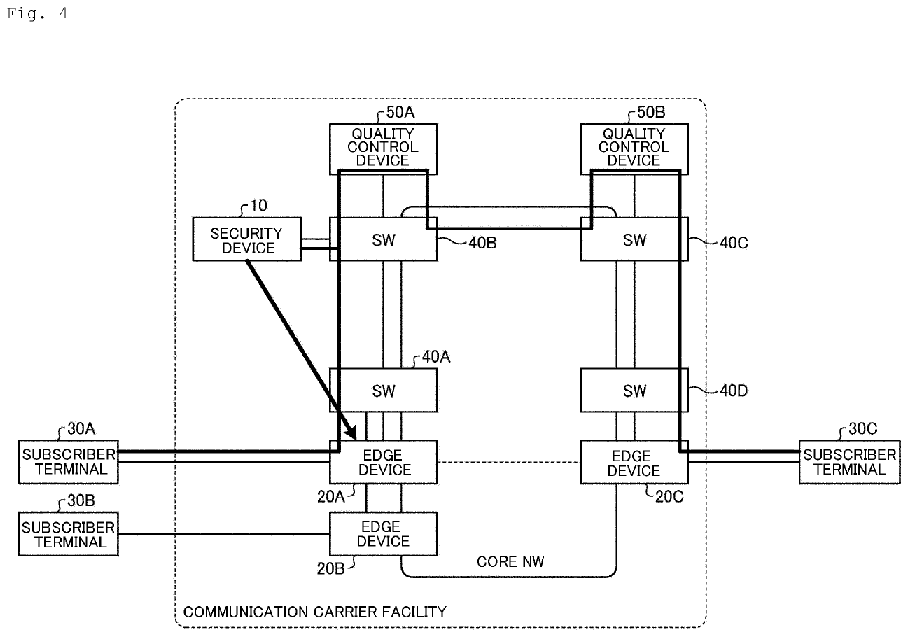

Thus, for example, as shown in FIG. 4, the security device 10 can instruct the edge device 20A of the VLAN in which the unauthorized communication has occurred to block the unauthorized communication. FIG. 4 is a diagram showing a process in which the security device instructs to block unauthorized communication. That is to say, the security device 10 does not require a database (DB) or the like in which updated information on notification destinations for instructing the blocking of unauthorized communications is constantly managed and it is possible to reduce costs. Furthermore, the security device 10 can request a response from the edge device 20A which can block the attack traffic by performing publicity directly using the communication path of the VLAN used by the attack traffic and implement blocking of unauthorized communication by applying blocking conditions on the identified edge device 20A side.

### Processing Procedure of Security Device

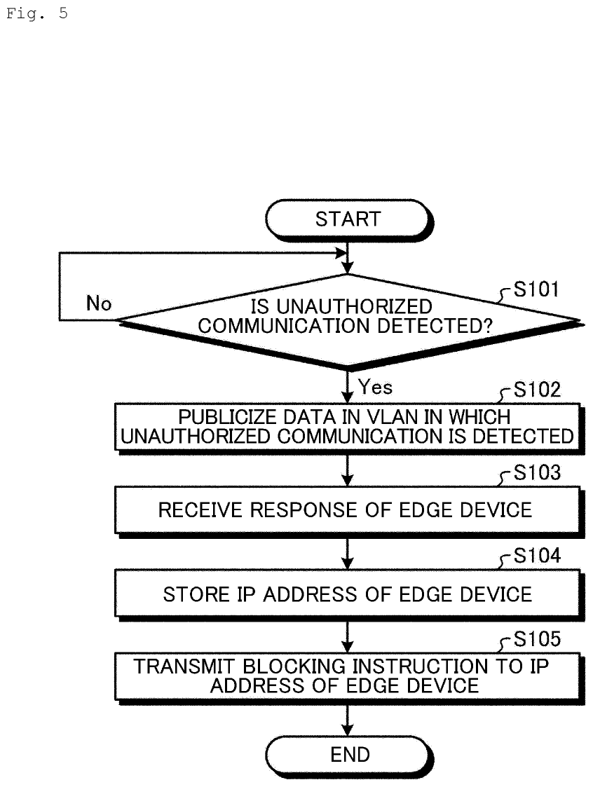

An example of a procedure of processing performed by the security device 10 will be described below with reference to FIG. 5. FIG. 5 is a flowchart for describing an example of a security processing procedure.

As shown in FIG. 5, for example, if the detection part 12a of the security device 10 detects unauthorized communication (Yes in Step S101), the identification part 12b broadcasts data in the VLAN in which the unauthorized communication was detected (Step S102) and receives a response from the edge device 20 in the VLAN (Step S103).

Also, the identification part 12b stores the IP address of the identified edge device 20 in the edge device address storage part 13a (Step S104). Subsequently, the communication control part 12c transmits a cutoff instruction to the IP address of the edge device 20 (Step S105).

### Effects of Embodiment

In this way, the security device 10 according to the embodiment detects unauthorized communication in each VLAN in a network in which each edge device 20 is logically divided into different VLANs. Also, when the security device 10 detects an unauthorized communication, it announces predetermined data in the VLAN in which the unauthorized communication is detected and identifies the edge device 20 in the VLAN based on the response to the announcement.

Subsequently, the security device 10 instructs the identified edge device 20 to control communication against unauthorized communication. For this reason, the security device 10 can appropriately control communication while reducing the cost of information management.

That is to say, in the related art, if the security device performs centralized analysis, a mechanism which identifies the destination of blocking instructions based on information such as information on IP packets determined to be fraudulent is required and it is expensive to keep it constantly updated. On the other hand, the security device 10 according to the embodiment can identify the device which will be notified to block unauthorized communications by using information other than the own management information thereof. In addition, there is no need for a database to constantly keep up-to-date information on notification destinations for instructing the blocking of unauthorized communications and costs can be reduced.

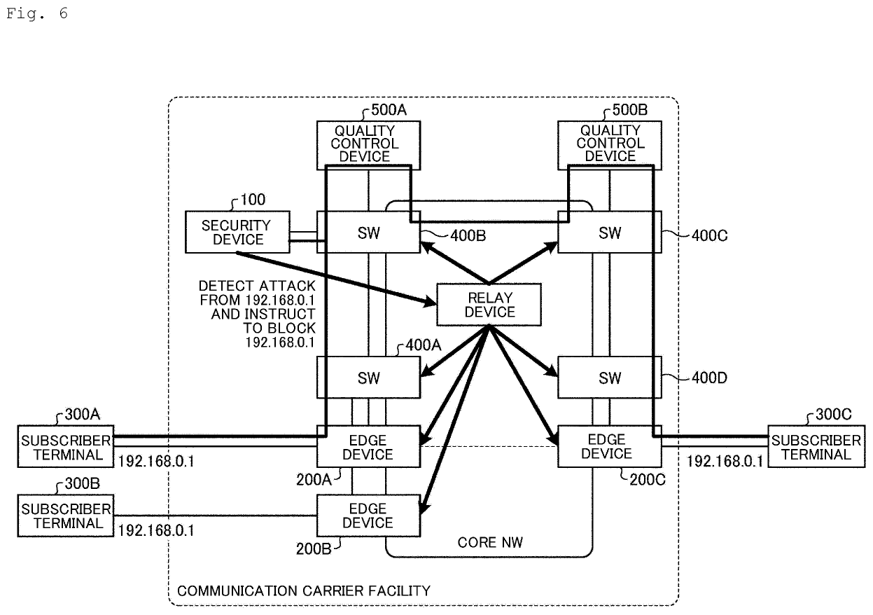

In addition, in the related art, when broadcasting settings like BGP Flowspec and having the communication device which receives the settings decide whether the settings are necessary and implement the settings, it becomes difficult to make a decision if there are duplicate IP addresses. For example, as shown in FIG. 6, in the related art, with BGP Flowspec and the like, the security device publicizes instructions to the whole to block the terminal whose IP address detected the attack via a relay device which relays the notification and the corresponding edge device performs the blocking process. FIG. 6 is a diagram showing problems when using BGP Flowspec in the related art.

However, in communications with a large number of target users, it is possible to convert IP addresses using network address port translation (NAPT) or the like to allow duplication of IP addresses of subscriber terminals. For this reason, in the related art, if blocking is performed using only the IP address, there is a concern that it would go as far as blocking communications which are not targeted and it is impossible to perform blocking by publicizing the targeted IP address.

For example, as exemplified in FIG. 6, when a subscriber terminal 300A and a subscriber terminal 300B have the same IP address “192.168.0.1” and only subscriber terminal 300A is performing unauthorized communication, if the security device 100 instructs the relay device to cut off communication with the IP address “192.168.0.1”, communication between both the subscriber terminal 300A and the subscriber terminal 300B is cut off.

On the other hand, the communication system according to the embodiment is a network in which each edge device 20 is logically divided into different VLANs. In addition, the security device 10 identifies the edge device 20 in the VLAN in which unauthorized communication is detected and instructs the edge device 20 in the VLAN to control communication against unauthorized communication. Thus, if the IP addresses of the subscriber terminals 30 do not overlap in the VLAN, it is possible to block the communication of only the subscriber terminal 30 which is performing unauthorized communication.

### System Configuration and the Like

The components of the illustrated devices according to the embodiment are functional and conceptual and do not necessarily need to be physically configured as illustrated. That is to say, the specific form of dispersion/integration of each device is not limited to what is shown in the diagram and all or a part of them can be configured by functionally or physically distributing and integrating them into arbitrary units in accordance with various loads and usage conditions. Furthermore, all or a part of processing functions performed by each device can be realized by a CPU and a program which is analyzed and performed by the CPU or can be realized as hardware using wired logic.

Also, among the processes described in the embodiments, all or a part of the processes described as being performed automatically can also be performed manually. Alternatively, all or a part of the processes described as being performed manually can also be performed automatically using known methods. In addition, information including processing procedures, control procedures, specific names, and various data and parameters shown in the above identification and drawings may be changed arbitrarily, unless otherwise identified.

### Program

Furthermore, it is also possible to create a program in which the processing performed by the security device 10 described in the embodiment is written in a computer-executable language. In this case, when the computer executes the program, the same effects as in the embodiment can be obtained. Furthermore, the same processing as in the embodiment may be realized by recording such a program on a computer-readable recording medium and having the computer read and execute the program recorded on this recording medium.

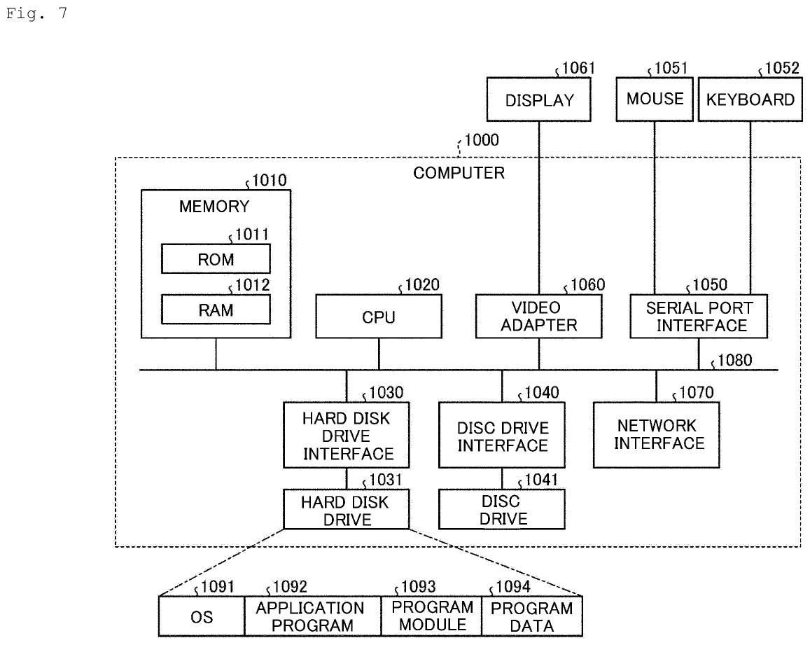

FIG. 7 is a diagram showing a computer which executes a program. As exemplified in FIG. 7, a computer 1000 includes, for example, a memory 1010, a CPU 1020, a hard disk drive interface 1030, a disk drive interface 1040, a serial port interface 1050, a video adapter 1060, and a network interface 1070 and these parts are connected to each other via a bus 1080.

The memory 1010 includes a read only memory (ROM) 1011 and a RAM 1012, as illustrated in FIG. 7. The ROM 1011 stores, for example, a boot program such as basic input output system (BIOS). The hard disk drive interface 1030 is connected to the hard disk drive 1031, as illustrated in FIG. 7. The disk drive interface 1040 is connected to the disk drive 1041, as illustrated in FIG. 7. For example, a removable storage medium such as a magnetic disk or an optical disk is inserted into the disk drive 1041. The serial port interface 1050 is connected to, for example, a mouse 1051 and a keyboard 1052, as illustrated in FIG. 7. The video adapter 1060 is connected to the display 1061, for example, as illustrated in FIG. 7.

Here, as illustrated in FIG. 7, the hard disk drive 1031 stores, for example, an OS 1091, an application program 1092, a program module 1093, and program data 1094. That is to say, the above program is stored, for example, in the hard disk drive 1031 as a program module in which commands to be executed by the computer 1000 are written.

Also, the various pieces of data described in the embodiment are stored in, for example, the memory 1010 or the hard disk drive 1031 as program data. In addition, the CPU 1020 reads the program module 1093 and the program data 1094 stored in the memory 1010 and the hard disk drive 1031 to the RAM 1012 as necessary and performs various processing procedures.

Note that the program module 1093 and the program data 1094 relating to the program are not limited to being stored in the hard disk drive 1031, but may be stored in, for example, a removable storage medium and read by the CPU 1020 via a disk drive or the like. Alternatively, the program module 1093 and the program data 1094 relating to the program may be stored in another computer connected via a network (local area network (LAN), wide area network (WAN), and the like) and be read by the CPU 1020 via the network interface 1070.

Although the embodiments to which the invention made by the present inventors is applied have been described above, the present invention is not limited by the description and drawings which form a part of the disclosure of the present invention according to the embodiments. That is to say, all other embodiments, examples, operational techniques, and the like made by those skilled in the art on the basis of the embodiment are included in the scope of the present invention.

### REFERENCE SIGNS LIST

10 Security device
11 Communication processing part
12 Control part
12a Detection part
12b Identification part
12c Communication control part
13 Storage part
13a Edge device address storage part
20A, 20B, 20C Edge device
30A, 30B, 30C Subscriber terminal
40A, 40B, 40C, 40D SW
50A, 50B Quality control device

1. A communication control device, comprising:
a detection part, including one or more processors, configured to detect unauthorized communication in each of VLANs in a network in which each edge device is logically divided into different VLANs;
an identification part, including one or more processors, configured to, in response to the detection part detect the unauthorized communication, publicize predetermined data in the VLAN in which the unauthorized communication was detected and identify an edge device in the VLAN on the basis of a response to the publicity; and
a communication control part, including one or more processors, configured to instruct the edge device identified using the identification unit to control communication with respect to the unauthorized communication.

2. The communication control device according to claim 1, wherein the identification part is configured to:
broadcast a DHCP IP address request message in the VLAN in which the unauthorized communication is detected;
receive a response to the message; and
identify the IP address of the edge device in the VLAN from information included in the received response.

3. The communication control device according to claim 1, wherein the identification part is configured to:
multicast, in the VLAN in which the unauthorized communication is detected, the RS message in the VLAN in which the unauthorized communication is detected;
receive a response to the RA message as a response to the message; and
identify the IP address of the edge device in the VLAN from information included in the received response.

4. The communication control device according to claim 1, wherein the communication control device is configured to:
notify the edge device identified using the identification part of an IP address at which communication is to be blocked; and
instruct communication control to block communication regarding the IP address.

5. A communication control method performed using a communication control device, comprising:
detecting unauthorized communication in each VLAN in a network in which each edge device is logically divided into different VLANs;
publicizing predetermined data in the VLAN in which unauthorized communication is detected;
identifying an edge device in the VLAN on the basis of a response to the publicity when the unauthorized communication is detected; and
instructing the identified edge device to control communication with respect to the unauthorized communication.

6. A communication control program causing a computer to execute:
detecting unauthorized communication in each VLAN in a network in which each edge device is logically divided into different VLANs;
publicizing predetermined data in the VLAN in which unauthorized communication is detected;
identifying an edge device in the VLAN on the basis of a response to the publicity when the unauthorized communication is detected; and
instructing the identified edge device to control communication with respect to the unauthorized communication.
